(19) United States
(12) Patent Application Publication
(10) Pub. No.: US 2014/0028853 A1
(43) Pub. Date: Jan. 30, 2014

(54) DUAL CAMERA DIGITAL VIDEO COMPARATOR FOR FORENSIC EVIDENCE

(71) Applicant: SIRCHIE Acquisition Company LLC, Youngsville, NC (US)

(72) Inventors: Dyer M. BENNETT, Raleigh, NC (US); Samuel HOLLIMAN, Durham, NC (US); James Stuart REYNOLDS, Louisburg, NC (US)

(21) Appl. No.: 13/947,706

(22) Filed: Jul. 22, 2013

Related U.S. Application Data
(60) Provisional application No. 61/675,126, filed on Jul. 24, 2012.

(51) Int. Cl. H04N 7/18

(52) U.S. Cl. CPC H04N 7/181
USPC 348/161

(57) ABSTRACT

A digital video comparator comprising a plurality of cameras and lenses for the comparison of forensic evidence configured to allow a user to view forensic evidence with a continuous video feed, capture images, and/or enhance the views through the use of incorporated lighting and matching filters. The images from the cameras may be viewed side-by-side in a display with independent controls for each image stream.

### CROSS-REFERENCE TO RELATED APPLICATIONS

This application claims benefit and priority of U.S. Provisional Application No. 61/675,126 filed Jul. 24, 2012, the disclosure of which is incorporated by reference herein in its entirety.

### BACKGROUND

1.0 Field of the Disclosure

This disclosure is directed generally to a digital video comparator and, more particularly, to a system and method for the comparison of forensic evidence configured to allow a user to view forensic evidence.

2.0 Related Art

Traditional forensic science uses matching as a standard practice. For example, fingerprints found at crime scenes may be compared to fingerprints taken from suspects and other crime scenes. In the field of ballistics, as another example, bullet projectiles may be compared to determine what gun might have fired them. Also, comparison may be done with trace evidence, such as, for example, comparing those hairs, fibers, and small items found at the crime scene to known profiles and standards.

In the field of fingerprint comparison, the examiners may utilize magnifiers to compare a set of latent fingerprints from a crime scene to a set of taken prints, produced from a suspect. Examiners may utilize comparators and/or optical instruments to magnify the details of the fingerprint to identify specific features for matching one fingerprint to another. Current dual comparison systems utilize light projected onto a surface where the evidence may be placed and either projects the reflected light through a series of magnifying lenses onto an opaque surface or utilizes a camera and lens to display the images on a CRT monitor, typically at equal or lower than VGA quality (680×400 resolution).

Currently, digital magnifiers that utilize a digital camera to project magnified images through digital video monitors only provide one camera, limiting flexibility of the comparison analysis. These systems have been utilized in forensics, but have traditional usage in electronics and other industrial inspection applications.

### SUMMARY OF THE DISCLOSURE

The present disclosure provides a much improved system and method for use in forensic science that includes multiple advantageous features to provide better and timelier forensic examinations and reviews. The system and method provides a much improved capabilities over currently available systems and methods

In one aspect, a comparator system is provided comprising a vertical mounting structure, a plurality of movable arms connected to the vertical mounting structure, a plurality of cameras, each camera mounted to a respective one of the plurality of movable arms and a computer communicatively coupled to the plurality of cameras, the computer configured to receive image signals from the plurality of cameras for forensic analysis.

In one aspect, a comparator system is provided comprising a mounting structure, a plurality of movable arms connected to the mounting structure, a plurality of cameras, each camera mounted to a respective one of the plurality of movable arms, a plurality of independently controllable light sources connected to each of the plurality of cameras, and a computer communicatively coupled to the plurality of cameras, the computer configured to receive image signals from the plurality of cameras for forensic analysis.

In one aspect, a method of providing a comparator system includes the steps of providing a vertical mounting structure, connecting a plurality of movable arms to the vertical mounting structure, mounting a plurality of cameras to a respective one of the plurality of movable arms, and coupling a computer to the plurality of cameras, the computer configured to receive image signals from the plurality of cameras for forensic analysis. The method may further include the step of connecting a plurality of light sources to a respective one of the plurality of cameras. The plurality of light sources and plurality of cameras are movable in an x-axis, a y-axis and a z-axis.

### BRIEF DESCRIPTION OF THE DRAWINGS

The accompanying drawings, which are included to provide further understanding of the present disclosure, are incorporated in and constitute a part of this specification, illustrate examples of the present disclosure and together with the detailed description serve to explain the principles of the present disclosure. No attempt has been made to show structural details of the present disclosure in more detail than may be necessary for a fundamental understanding of present disclosure and the various ways it may be practiced. In the drawings:

FIG. 1 is a block diagram of an example of a comparator system, configured according to principles of the present disclosure; and

FIG. 2 is a block diagram of an example of a comparator system, configured according to principles of the present disclosure.

### DETAILED DESCRIPTION OF THE DISCLOSURE

The disclosure and the various features and advantageous details thereof are explained more fully with reference to the non-limiting examples that are described and/or illustrated in the accompanying drawing and detailed in the following description. It should be noted that the features illustrated in the drawing are not necessarily drawn to scale, and features of one example may be employed with other examples as the skilled artisan would recognize, even if not explicitly stated herein. Descriptions of well-known components and processing techniques may be omitted so as to not unnecessarily obscure the principles of the disclosure. The examples used herein are intended merely to facilitate an understanding of ways in which the disclosure may be practiced and to further enable those of skill in the art to practice the principles of the disclosure. Accordingly, the examples herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

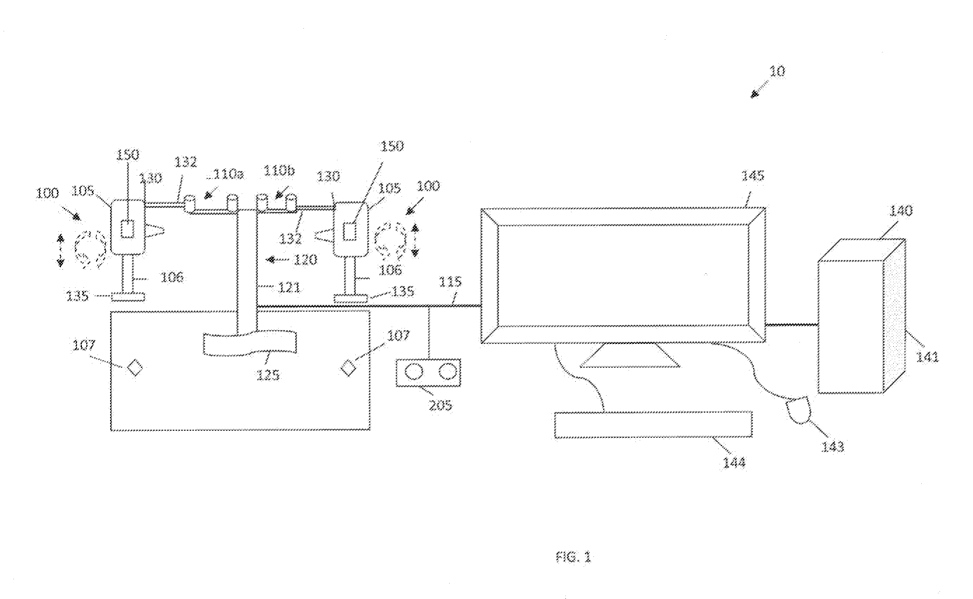

FIG. 1 is a block diagram of an example of a comparator system, configured according to principles of the present disclosure. Referring to FIG. 1, a comparator system 10 may comprise a plurality of camera and lens combination 100, each configured to be mounted on a movable swing arm 110a, 110b and the plurality of camera and lens combination 100 may be connectable via a communication link 115 such as, for example, a network. The network may be configured with, for example, a gigabit connection to a computing system that may utilize software to project the images through a video display monitor 145, preferably at high definition. A camera 105 may be configured with a lens 106. The plurality of camera and lens combination 100 may include a color imaging system that may produce a digital image on the video display monitor 145 and may have a magnification range, for example, from 3× to 30× magnification. Other magnifications are possible. Preferably, the cameras comprise at least an 8 megapixel (MP) color video, 4/3″ color sensor, 10 frames/sec at full 8 MP resolution. The cameras 105 may be powered by a power source, such as for example, a 12V power source and may have an output for digital raw images at up to or exceeding, for example, 1 gigabit per second. A user input device such as a mouse 143 may be utilized by a user to select and navigate through user options presented on the video display monitor 145, in accordance with goals of a user when using the comparator system 10, such as, e.g., analyzing or viewing forensic evidence 107 (which may be a different target for each camera).

A mounting structure 120 may comprise a vertical portion 121 that may be configured to permit dual swing arms 110a, 110b to be moved vertically up and/or down. The mounting structure 120 may be configured to include a mounting base 125 and two swing arms 110a, 110b that may be configured to rotate laterally, perhaps with a radius of motion of 180 degrees. The swing arms 110a, 110b may be configured with tensioning such as a spring tensioner and may be configured to be raised and lowered in the Z-axis. The mounting plates 130 for the cameras 105 may be configured to permit independent +/−90 degree rotation of the cameras 105, thereby allowing the respective camera to be utilized in a parallel plane to a mounting surface. The plurality of cameras 105 may be movable in an x-axis, a y-axis and a z-axis.

A plurality of lighting systems 135 (or light sources) may be configured to be mounted or associated with a respective camera/lens 100 on the mounting structure 120. The plurality of lighting systems 135 may be configured to selectively project white, blue, UV light and/or any combination of additional wavelengths including green, cyan, amber, red and infrared (IR) onto the surface or target object being viewed by a respective camera 105. The lighting system 135 may be configured to mount onto a respective camera 105 which may be configured to be mounted on an articulating armature 132, to provide adjustments of the swing arms 110a, 110b, so that as a respective camera 105 is moved, the associated lighting system 135 moves in tandem. The plurality of lighting systems 135 may also be movable in an x-axis, a y-axis and a z-axis.

This arrangement may keep a lighting system 135 directed on the same target 107 as the associated camera 135. The lighting system 135 may be connected to the articulating armature 132 either fixedly (such as by screws, for example) or detachably reconnectable. In some implementations, the lighting system 135 may be connected to the associated camera 105, either fixedly or detachably reconnectable. A quick release connector may be employed so as to be detachably reconnectable. The plurality of lighting systems 135 may be independently movable in an x-axis, a y-axis and a z-axis.

In one aspect, the lighting systems 135 may be powered by integration into the comparison system, so that a common power supply may feed the lights and may also power the cameras. However, separate voltages may be provided such as, for example, 4 volts for the lights and 12 volts for the cameras. In some implementations, separate power supplies may be used. These lights may be used to illuminate the evidence being examined to enhance features or to increase contrast. Specific filters may be utilized with the lenses that permit enhancements to the images. The filters may be manually changed by a user. The filters, e.g., yellow and orange filters, may be affixed or removed easily such as via a magnetic attachment.

The computer 140 may receive and store any images produced by the plurality of camera and lens combination 100. The computer 140 may store such images as selected by a user to a database 141 for later retrieval and processing and/or viewing such as on video display monitor 145, which may be a high definition monitor. In some implementations, the computer 140 may be configured to also function as a server. In some applications, the computer 140 may be connected to multiple camera/lens combinations 100 to serve multiple users, perhaps remotely. The communication link 115 may be connected to a wide-area network so that a remote database may be accessed by computer 140. Database 141 may be remotely located and shareable. A server may permit multiple users to access, e.g., a plurality of cameras/lens combinations 100 and/or the database 141 for accessing any stored images or storing images from the plurality of cameras/lens combinations 100. In some implementations, a server may provide access for many users to many camera/lens combinations 100 and/or the database 141. The server may permit the light systems 135 to be controlled remotely. The lens 106 may be controlled, such as, e.g., focusing, via the computer 140, or, in some implementations, remotely controllable by a user. Moreover, the lens 106 may be controlled or adjusted manually.

A user may control the lighting system 135 using controller 150 to select different light settings, e.g., to turn any light source on/off, select a light frequency or light frequency range, or to vary intensity. The controller 150 may be configured to independently control each of the plurality of light systems 135. The individual light sources (e.g., white light, ultraviolet light and Blue light) of the light system 135 may include selectable frequency ranges including a UV frequency range, a white light frequency range and/or a blue light frequency range. The lighting system 135 may comprise one or more light sources configured to emit light ranging in frequency from the ultraviolet (UV) wavelength to the infrared wavelength, including blue, red and green frequencies. Moreover, the one or more light sources may be configured to be selectable by a user for choosing a particular frequency range or wavelength (e.g., UV, red, blue, green, cyan, amber, and infrared). One light system 135 may be selected to project one frequency range while the other companion light systems 135 might be configured to project another frequency range, for example. In one aspect, selectable wavelengths might include, e.g., white (about 560K), royal blue (455 nm) and UV (about 395 nm) to enhance evidence examination, and may be fully dimmable and independently selectable for each camera.

Each camera 105 may stream images to the computer 140 via communication link 115. Images from each camera 105 may be displayed on the video display monitor 145, perhaps in separate software generated windows for each stream. A user may capture a frame from either stream (i.e., from either camera 105) for storage in the database 141 for later recall, perhaps as part of the computer 140, or perhaps as a distributed or a remotely coupled database. The file stored may be stored in different formats as selected by a user. Images may be captured under any of the selected light sources (e.g., white light, UV light and Blue light). A user may establish a file system perhaps using a standard operating system such as, for example, a Windows® operating system from Microsoft Corporation. Video control software may be executed by computer 140 and may comprise a viewer. The software video platform or viewer may include software from Sirchie Acquisition Company, LLC. The viewer may provide dual live images, image capture, enhancement, annotation, color correction and/or case documentation, among other features. The viewer may permit independent control of the images from each camera.

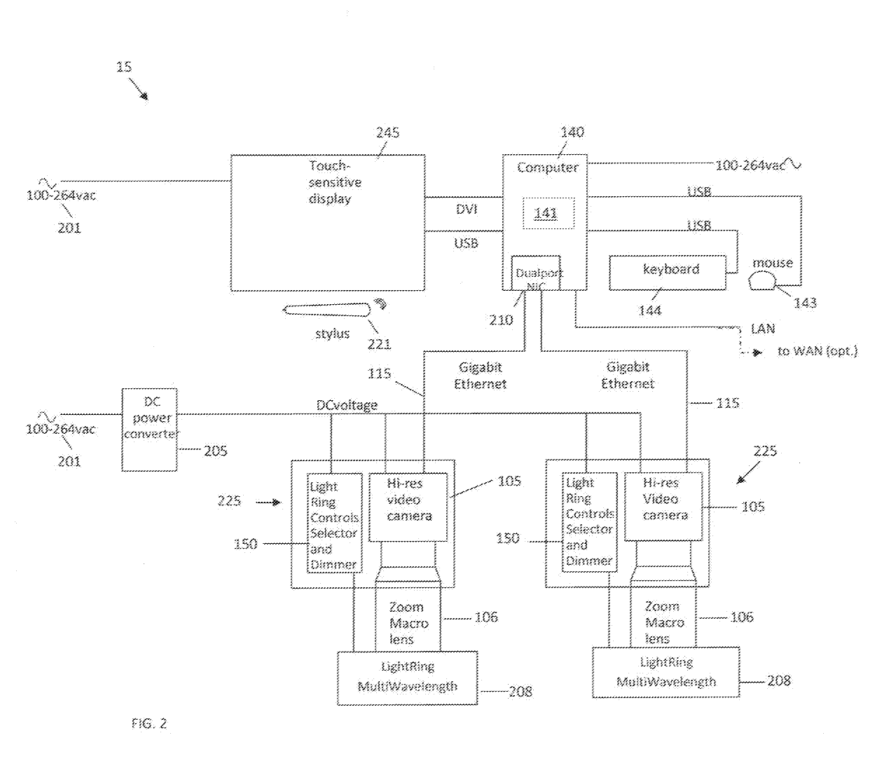

FIG. 2 is a block diagram of an example of a comparator system, configured according to principles of the present disclosure. Referring to FIG. 2, a comparator system 15 may comprise a plurality of camera and lens combinations 225 which may be connectable via a communication link 115 such as, for example, a network. The network may be configured with, for example, a gigabit connection 115, e.g., a gigabit Ethernet connection, to a computing system such as computer 140 that may utilize software to project the images through a video display monitor 245, preferably at high definition. Other speed networks may be used as warranted. In some applications, the video display monitor 245 may be configured as a touch sensitive display to receive user inputs. The cameras 105 may be configured with lenses 106, which may be zoom lenses. The plurality of camera and lens combinations 225 may include a color imaging system that may produce a digital image on the video display monitor 245 and may have a magnification range, for example, from 3× to 30× magnification. Other magnifications are possible. The cameras 105 may be powered by a power source, such as for example, a 12V power source and may have an output for digital raw images at up to or exceeding, for example, 1 gigabit per second. A DC power converter 205 may be employed to convert 100-264 VAC to direct current (DC). A user input device such as a mouse 143 or a stylus 221 may be utilized by a user to select and navigate through user options presented on the video display monitor 245, in accordance with goals of a user when using the comparator system 15, such as, e.g., analyzing or viewing forensic evidence.

Referring to FIG. 2, the computer 140 may be configured with one or more network interface cards (NIC) 210 for connecting to the communication link 115. The computer may also be configured with universal serial buses (USB) and/or digital visual interfaces (DVI). A light source, e.g., light ring 208, may selectively produce light in one or more different frequency ranges, as selected by a user. The light source 208 (which may be a plurality of light sources) may include frequencies selectable from at least one of: a UV frequency range, a red light frequency range, a blue light frequency range, a green light frequency range, a cyan frequency range, an amber frequency range, and infrared frequency range. One light source, e.g., light ring 208, may be selected to project one frequency range while the other companion light source, e.g., light ring 208, might be configured to project another frequency range. In this way, forensic evidence that may be under analysis or viewing can be differentiated by selection of different light frequencies on each light source. The computer 140 may be configured to load software from a storage device and is configured to execute the software from a memory that permits a user to control viewing and capturing of images from the cameras 105. The software may be configured to control storage of the video in different formats and to retrieve the video as required by a user. The software may be configured to permit a user to annotate any video or frames for storage in a database such as database 141.

In one aspect, an imaging system for forensics may comprise at least one camera and may be configured to be mounted to a movable mount and at least one light system mounted to the movable mount. The movable mount may be connected to a base portion and vertically elevated and space apart from the base. A separate light system may be associated with a respective camera. The movable mount may be configured to move in the x-axis, the y-axis and the z-axis. The moveable mount may comprise an articulating arm connected to a second arm that may be rotatable in a plane parallel to a base surface upon which the imagining system stands. The second arm may be connected to a vertical support structure for vertical elevation of the at least one camera and at least one light system. The light system may comprise multiple selectable light sources configured to project light in different frequency ranges including a UV frequency range, a white light frequency range and/or a blue light frequency range. The light system may be user controllable for selecting among the selectable light sources.

In one aspect, the system and methods of the disclosure may permit comparing of forensic evidence from the plurality of cameras. The images form each camera may be independently controllable, storable and viewable. Each camera may be independently controlled such as, e.g., changing lighting, changing focusing or filters, changing position, and the like.

While the disclosure has been described in terms of exemplary examples, those skilled in the art will recognize that the disclosure can be practiced with modifications in the spirit and scope of the appended claims. These examples are merely illustrative and are not meant to be an exhaustive list of all possible designs, applications or modifications of the disclosure.

What is claimed is:

1. A comparator system, comprising:
a vertical mounting structure a plurality of movable arms connected to the vertical mounting structure;
a plurality of cameras, each camera mounted to a respective one of the plurality of movable arms; and
a computer communicatively coupled to the plurality of cameras, the computer configured to receive image signals from the plurality of cameras for forensic analysis.

2. The comparator system of claim 1, further comprising a plurality of light sources associated with a respective one of the plurality of cameras.

3. The comparator system of claim 2, wherein the plurality of light sources are mounted to a respective one of the plurality of cameras.

4. The comparator system of claim 2, wherein the plurality of light sources are movable in an x-axis, a y-axis and a z-axis.

5. The comparator system of claim 1, wherein each of the plurality of cameras are movable in an x-axis, a y-axis and a z-axis.

6. The comparator system of claim 1, further comprising a light controller operatively connected to the plurality of light sources.

7. The comparator system of claim 6, wherein the light controller is configured to select different light settings for each of the plurality of light sources.

8. The comparator system of claim 7, wherein the different light settings include being selectable based on different light wavelengths and light intensity.

9. The comparator system of claim 1, further comprising a database operatively accessible by the computer for storing and/or reading the image signals.

10. The comparator system of claim 1, wherein the computer is communicatively coupled to the plurality of cameras over a network.

11. The comparator system of claim 1, wherein the computer comprises a server, the server configured to permit multiple users to access the plurality of cameras or the database.

12. A comparator system, comprising:
a mounting structure;
a plurality of movable arms connected to the mounting structure;
a plurality of cameras, each camera mounted to a respective one of the plurality of movable arms;
a plurality of independently controllable light sources connected to each of the plurality of cameras; and
a computer communicatively coupled to the plurality of cameras, the computer configured to receive image signals from the plurality of cameras for forensic analysis.

13. The comparator system of claim 12, wherein the plurality of light sources include frequencies selectable from at least one of: a UV frequency range, a red light frequency range, a blue light frequency range, a green light frequency range, a cyan frequency range, an amber frequency range, and infrared frequency range.

14. The comparator system of claim 12, wherein the plurality of light sources are movable in an x-axis, a y-axis and a z-axis.

15. The comparator system of claim 12, wherein each of the plurality of cameras are movable in at least one of: a x-axis, a y-axis and a z-axis.

16. The comparator system of claim 12, further comprising a light controller operatively connected to the plurality of light sources, wherein the light controller is configured to select different light settings for each of the plurality of light sources.

17. The comparator system of claim 16, wherein the different light settings includes different light wavelengths and different light intensities.

18. The comparator system of claim 12, further comprising a database operatively accessible by the computer for storing and/or reading the image signals.

19. The comparator system of claim 12, wherein the computer is communicatively coupled to the plurality of cameras over a network.

20. The comparator system of claim 12, wherein the computer comprises a server, the server configured to permit multiple users to access the plurality of cameras and/or the database.

21. A method of providing a comparator system, comprising the steps of:
providing a vertical mounting structure;
connecting a plurality of movable arms to the vertical mounting structure;
mounting a plurality of cameras to a respective one of the plurality of movable arms; and
coupling a computer to the plurality of cameras, the computer configured to receive image signals from the plurality of cameras for forensic analysis.

22. The method of claim 21, further comprising the step of connecting a plurality of light sources to a respective one of the plurality of cameras.

23. The method of claim 22, wherein the plurality of light sources and plurality of cameras are movable in an x-axis, a y-axis and a z-axis.
